(19) United States
(12) Patent Application Publication
(10) Pub. No.: US 2017/0272149 A1
(43) Pub. Date: Sep. 21, 2017

(54) INTER-SATELLITE SPACE COMMUNICATION SYSTEM - METHOD AND APPARATUS

(71) Applicant: Paris MICHAELS, Sydney (AU)

(72) Inventor: Paris MICHAELS, Sydney (AU)

(21) Appl. No.: 15/531,432

(22) PCT Filed: Nov. 28, 2015
(86) PCT No.: PCT/IB2015/059189

§ 371 Date: May 28, 2017

(30) Foreign Application Priority Data
Nov. 28, 2014 (AU) 2014904819

(51) Int. Cl. H04B 7/19; H04L 27/34; G01S 19/14; G01S 5/00; H04B 7/185; G01S 5/14

(52) U.S. Cl. CPC H04B 7/19; H04B 7/185; H04B 7/18528; G01S 5/14; G01S 19/14; H04B 7/18567; G01S 5/0081; H04L 27/3455

(57) ABSTRACT

A method and apparatus for zero interference multi-gigabit inter-satellite communication between system satellites (300) and client satellites (301) using millimeter wave beams at transmit and receive frequencies that are aligned to the peak atmospheric molecular absorption frequencies in the electromagnetic spectrum (FIG. 1). The narrow low power beams are accurately steered within a restricted set of directions (FIG. 5) that prevent interference to other space borne radio receivers whether in geostationary or low earth orbits and cannot interfere with terrestrial receivers due to atmospheric absorption. The apparatus comprises an integrated electronically steered 2-D phased array (401), transceiver and baseband integrated circuits (402, 403) with a beam controller (404) coupled to the spacecraft attitude determination and control subsystem (407), central processing unit (406) and solid state storage device (405).

### FIELD

The invention relates to wireless communication systems, methods and apparatus in particular to satellite communication systems, methods and apparatus.

### BACKGROUND

Constellations of small satellites have great potential to alleviate the digital divide between rural and metropolitan communities and also in less connected regions of the Earth.

Small satellites have important scientific and industrial applications that include high resolution data telemetry from miniature instruments such as visible light and infra-red high speed cameras, hyper-spectral cameras, synthetic aperture radars, reflectometers, altimeters and spectrometers used to further Earth observation sciences and Space research

A key improvement that enables the more effective application of small satellites is the capability to communicate via ultra high capacity, multi-gigabit inter-satellite links.

### SUMMARY

The problem with small satellites is the limited electrical power and antenna area which directly limit the practical data rates in the prior art. Another problem is the brief periodic visibility of non-geostationary satellites to a ground station which typically reduces the data that can be returned to Earth by a factor of 100 compared to continuous visibility. Another problem is the satellite velocity relative to a ground station which requires high accuracy pointing and tracking of large ground station antennas and causes severe Doppler shift at high frequencies.

In the present invention the many problems of capturing large volumes of data from small satellites are solved by a method of inter-satellite space based communication at frequencies that are aligned with atmospheric molecular absorption spectra that are ideal for communication between space objects because they are heavily attenuated by atmospheric gases (FIG. 1) and therefore cannot cause strong interference to terrestrial receivers operating at the same frequencies. These various millimeter wave frequencies can support large information signal bandwidths and multi-gigabit data rates using small and low power integrated transmitting and receiving circuits and small client satellite antennas even at inter-satellite distances of hundreds or thousands of kilometers. Further the relative satellite velocities can be an order of magnitude smaller when the client and system satellites happen to be in co-rotating orbits which increases the visibility or link time and reduces the Doppler shift.

In the prior art, if the target satellite is at the radio horizon a portion of the wider return beam may intersect with the Earth potentially causing interference to terrestrial receivers operating at the same frequency. At low elevation angles this return beam may interfere with terrestrial point-to-point links that use high gain parabolic antennas. In the present invention this cannot occur as the intervening atmosphere rapidly and severely attenuates the beam to a level much less than the minimum detectable signal of such unintended receivers. The so called free space path loss is additional to the gaseous absorption attenuation and so the total path loss at a distance of 600 km is over 330 dB. In summary even high gain antennas at sea level pointing directly at the source would fail to detect such a heavily attenuated low power signal.

A perfect example of such an atmospheric gaseous absorption spectrum is the 60 GHz O₂ absorption spectrum (FIG. 2) which strongly attenuates signals between 54 Ghz and 66 GHz by more than 10 dB per kilometre in both dry (FIG. 1 curve B) and standard atmosphere conditions (7.5 g/m³) at sea level (FIG. 1 curve A). At altitudes suitable for Low Earth Orbit (LEO) the atmospheric density is many orders of magnitude lower than at sea level and so the atmospheric attenuation is negligible for the purpose of inter-satellite communications. At 620 km above sea level the atmospheric density is typically within the range 9.1×10⁻¹⁵ to 1.48×10⁻¹² (kg/m³) depending on location and short and long term solar activity.

It will be understood that in the spirit of the present invention the 60 GHz band is one of several bands that are suited to zero terrestrial interference inter-satellite space communications. Other electromagnetic frequency bands which coincide with atmospheric absorption spectra include the 118 GHz line.

### BRIEF DESCRIPTION OF DRAWINGS

The various features and advantages of the present invention may be more readily understood with reference to the following detailed description taken in conjunction with the accompanying drawings, wherein like reference numerals designate like structural elements, and in which:

FIG. 1 shows the magnitude and location of the terrestrial atmospheric molecular absorption peaks in the electromagnetic spectrum up to 1000 GHz.

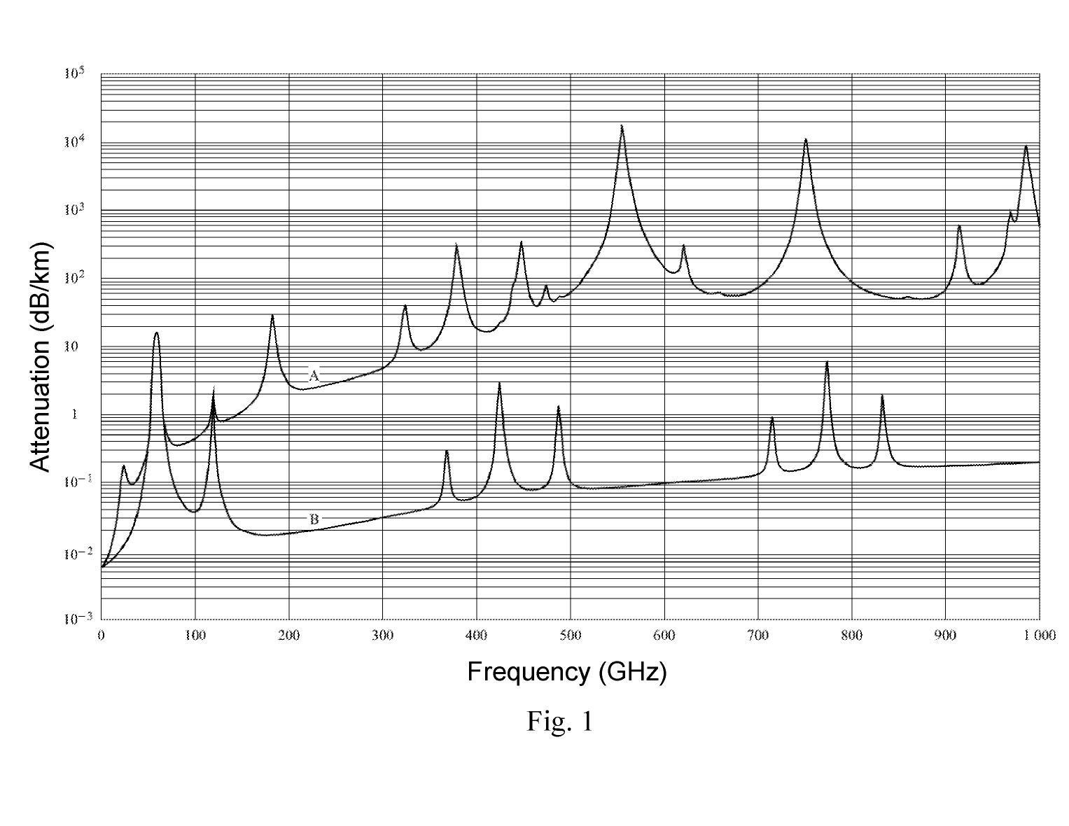

FIG. 2 shows the magnitude of the attenuation and absorption of electromagnetic energy at 60 GHz at various elevation angles.

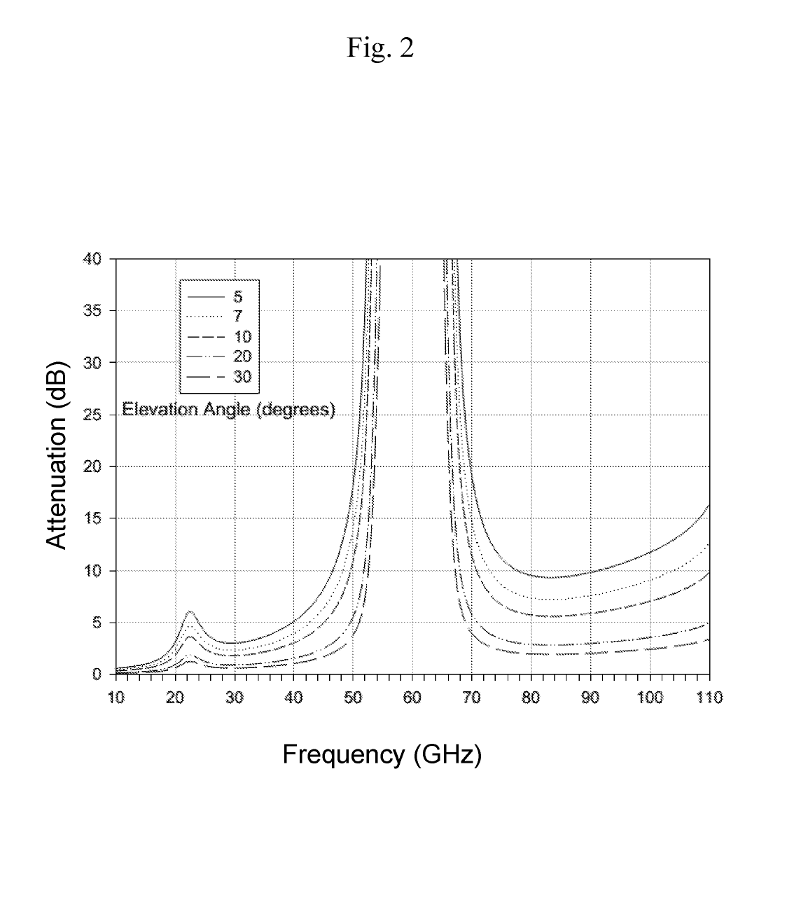

FIG. 3 illustrates the inter-satellite communication system satellites, a client satellite and an earth station gateway.

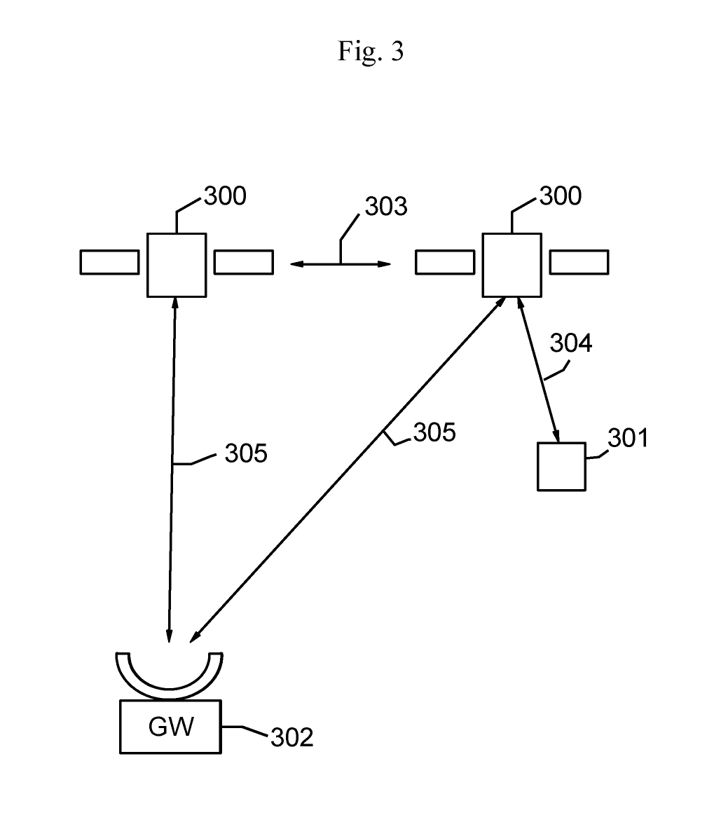

FIG. 4 is a schematic diagram of an embodiment of the inter-satellite space communication apparatus.

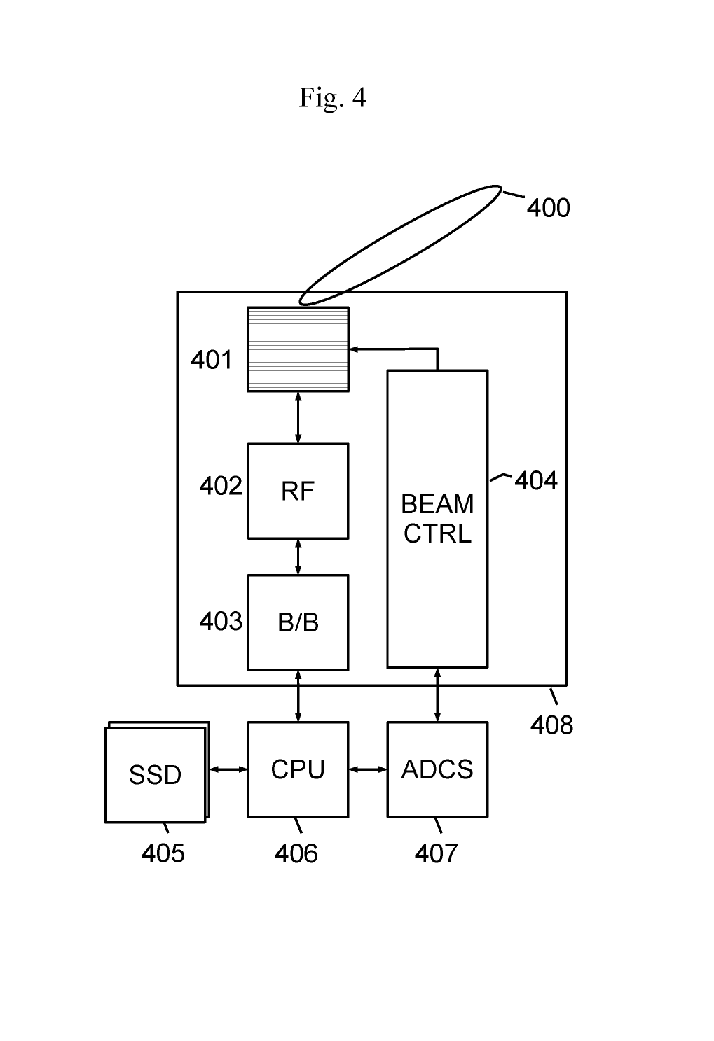

FIG. 5 illustrates the restricted range of beam directions that prevent interference to and from geostationary satellites.

### DESCRIPTION OF EMBODIMENTS

In one embodiment of the present invention a satellite transmitter operating at a center frequency of 60 GHz inputs a modulated ultra-wideband signal at a maximum AC power of 24 dBm to a 60 dBi directional antenna beam pointed at a target satellite 301 in orbit at a 600 km altitude above the Earth. The target satellite 301 may have a lower gain (36 dBi) receiving antenna with a main lobe −3 dB beam width of 3 degrees.

The target satellite may acknowledge (ACK) successful or unsuccessful (NACK) transmissions in either a time domain duplex (TDD) or Frequency domain duplex (FDD) fashion, either transmitting to the source satellite at the same frequency or preferably at another duplex frequency lying within the same or a different absorption band. At short range TDD is advantageous as higher speed, wider bandwidth communications are possible. At long range, such as at the radio horizon, the round trip time (RTT) required for ACK or NACK may consume much or all the link availability time and FDD is preferred so as to permit time efficient concurrent transmitter operation at multi-gigabit per second data rates.

A particularly useful embodiment of the invention is to “Cubesat” satellites to eliminate terrestrial radio interference and improve data communications. Applications include high resolution data telemetry from miniature instruments such as visible light and infra-red high speed cameras, hyper-spectral cameras, synthetic aperture radars, reflectometers, altimeters and spectrometers used to further Earth observation sciences research.

In one embodiment of the invention the system has system satellites in polar orbits which can establish inter-satellite communications links 303 to both system 300 and client satellites 301. To illustrate this aspect by example, the first such system satellite will be in a polar orbit with inclination 97.8 degrees at a mean altitude of 622 km. A polar orbit has many advantages, including the ability to launch the satellite from virtually any country, the visibility of the satellite daily at high elevation angles to ground stations globally, and the high probability that the satellite orbit will be within range periodically of client satellites for the purpose of establishing inter-satellite links. This example should not be understood as limiting the scope of the invention to a specific orbit as higher or otherwise different orbits may be used without departing from the spirit of the invention and the invention inherently encompasses a multiplicity of orbits occupied by a multiplicity of satellites operating within the inter-satellite communications system.

In another aspect of an embodiment of the invention the inter-satellite communications transceiver includes a “WiGig” or IEEE 802.11ad transceiver 402 and baseband integrated circuit 403. Such integrated circuits will be mass produced in 2015 in a 28 nm CMOS process and can deliver multi-gigabit data rates at low power consumption in a small package.

In another aspect of an embodiment of the invention the inter-satellite communications transceiver includes a substrate integrated waveguide transition between the radio frequency transmitter output and a transmit path switch connected to the input of a power amplifier circuit that has a saturated power output of 24 dBm that is connected to the antenna switch, that is connected to the antenna.

In another aspect of the embodiment of the invention the antenna is a 2-dimensional phased array antenna 401 which forms beams 400 that can be scanned in the X and Y planes with a resolution of less than 0.1 degree. The antenna beam scanning and control sub-system 404 is coupled to the satellite Attitude Determination and Control System (ADCS) 407 and system central processing unit 406 such that the antenna 401 can accurately point and track the target satellite 300 and 301 while compensating residual motion that would otherwise upset the accurate pointing of the antenna. This can allow compact, low cost passive stabilization mechanisms to be employed by small client satellites 301.

In another aspect of an embodiment of the invention the satellites store communicated data on-board the satellite using non-volatile memory devices 405 such as solid state drives (SSD) which are available in capacities up to 2 Terabytes (TB) and can sustain multi-gigabit data transfers to and from the transceiver sub-system 408. This ensures that inter-satellite links 303 operate at peak efficiency and that data is stored until a system satellite 300 with inter-satellite communications capability 303 or a suitable ground station 302 is within range. To further enhance the system performance, reliability and radiation tolerance multiple SSD's in a Redundant Array of Independent Drives (RAID) 405 configuration can prevent loss of client data in the event of a SSD failure.

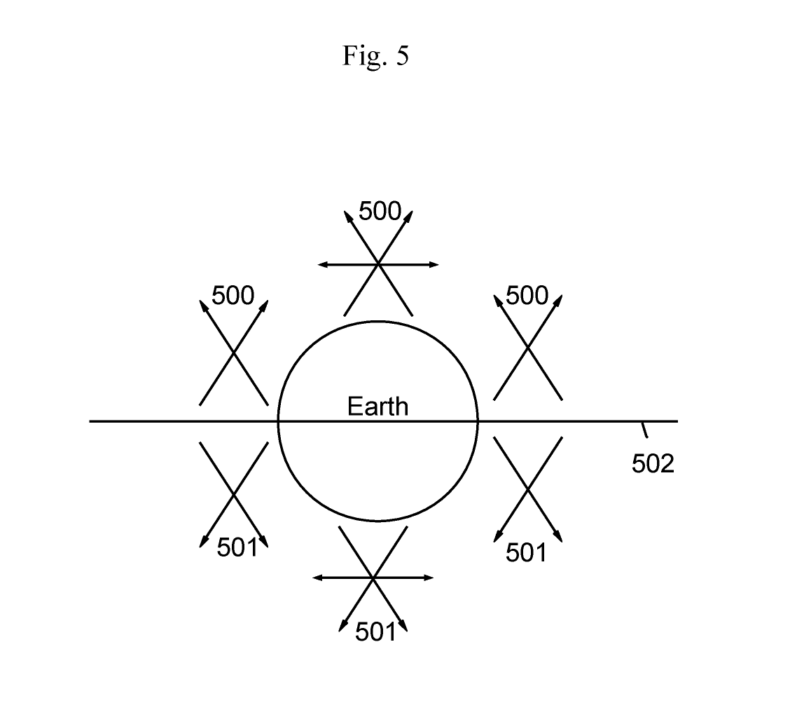

Referring now to FIG. 5 which illustrates the beam direction restrictions that are enforced by the beam controller 404 for communication between system satellites 300 and client satellites 301. The range of beam directions allowed for inter-satellite communication in the northern hemisphere 500 and southern hemisphere 501 are restricted such that a beam with a 3 dB beam width of less than 3 degrees cannot propagate interference to geostationary or geosynchronous (GEO) satellites located about the Earth's equatorial plane 502 at a distance of six Earth radii. Even at full power and maximum gain a system signal that reaches a geostationary satellite at a distance of 36,000 km will have a power spectral density (PSD) less than −137 dBm/Hz which is below the thermal noise floor of any satellite receiver with a bandwidth greater than 5 kHz and a noise temperature of 300 K.

Referring now to potential interference to other low earth orbit (LEO) satellites; due to the high orbital velocity of the system satellites and the narrow beam-width of the high gain antennas and the dynamic tracking of the beams between pairs of communicating satellites potential interference is unlikely and requires very precise dynamic alignment between the system satellite antenna and the unintended satellites' high gain antennas. The probability that a foreign satellite antenna beam with 25 dB gain or 45 dB gain at a range of 1000 km intersects with a system satellite beam is 1.77e-8 and 1.68e-9 respectively assuming worst case anti-parallel antenna orientations. Considering the probability of interference in terms of large satellite constellations, the total number of satellites must exceed 653 for an interference event to occur once daily at 25 dB gain and 6872 satellites at 45 dB gain. The duration of such an event would be of the order of a 4.5 seconds per degree of beam-width for orbits separated radially by 1000 km. In the present invention the high capacity solid state storage device 405 stores the inter-satellite communications data and prevents the loss of data during brief periods of automatically postponed satellite communications where unfavorable satellite ephemerides indicate potential interference that cannot be avoided by beam direction adjustments.

It will be understood that the described embodiments are merely illustrative of some of the many specific embodiments which represent applications of the principles of the present invention. Clearly, numerous and varied other arrangements may be readily devised by those skilled in the art without departing from the scope of the invention.

1. A method of zero interference potential inter-satellite communication between system satellites and client satellites using millimeter wave beams at transmit and receive frequencies that are aligned to the peak atmospheric molecular absorption frequencies in the electromagnetic spectrum and the beams are steered within a restricted set of directions that prevent interference to space borne radio receivers.

2. The method of claim 1 whereby the transmitted beams are steered away from the equatorial plane to effectively prevent interference to geostationary satellite receivers.

3. The method of claim 1 whereby the transmitted beams are steered within the angular diameter subtended by the Earth to effectively prevent interference to other satellites in low, middle or high earth orbits and terrestrial receivers.

4. The method of claim 1 where where the transmitted beams are steered substantially perpendicular to the Earth's surface to effectively prevent interference to other satellites in higher orbits using tangential inter-satellite links at the same frequencies.

5. The method of claim 1 where where the transmitted beams are steered with reference to accurate, real-time satellite ephemerides to effectively prevent potential interference to other satellites using inter-satellite links at the same frequencies.

6. The method of claim 1 where the antenna beam steering control processor is coupled to the satellite attitude determination and control system to perform accurate beam pointing and tracking of receiving or transmitting satellites.

7. An apparatus for inter-satellite communication comprising: integrated steerable two-dimensional phased array antenna; integrated circuits for transmitter, receiver or transceiver functions, baseband communication signal processing and digital input and output and control system interface functions; a spacecraft attitude determination and control system coupled to the antenna beam control system; a solid state non-volatile storage device with input and output interfaces to the communication sub-system.

8. The apparatus of claim 7 where the integrated circuit transceivers and baseband processors are IEEE 802.11AD or “WiGig™” compatible.

9. The apparatus of claim 7 where the electronically steered antenna array feeds or is coupled to a mesh or solid or inflatable reflector antenna to increase the antenna system gain.

10. The apparatus of claim 7 where the electronically steered antenna arrays feed and are coupled to a dielectric resonator antenna to increase the antenna system gain.
